(19) United States
(12) Patent Application Publication
(10) Pub. No.: US 2014/0185890 A1
(43) Pub. Date: Jul. 3, 2014

(54) Analyzing Medical Image Data

(71) Applicants: Vinodhkumar M, Electronic City (IN); Vishwesh Babu VishnuMurthy, Bangalore (IN)

(72) Inventors: Vinodhkumar M, Electronic City (IN); Vishwesh Babu VishnuMurthy, Bangalore (IN)

(21) Appl. No.: 14/142,259

(22) Filed: Dec. 27, 2013

(30) Foreign Application Priority Data
Dec. 27, 2012 (IN) IN 1469/KOL/2012

(51) Int. Cl. G06T 7/00

(52) U.S. Cl. CPC G06T 7/0012
USPC 382/128

(57) ABSTRACT

A system for analyzing a medical image data is provided. The medical image data includes data related to at least a candidate blood vessel affected due to change in blood perfusion behavior through the candidate blood vessel and related to various proximal blood vessels in proximity to the candidate blood vessel in the medical image data. The system includes a parameter generator that receives the medical image data, processes the medical image data, and generates parameters that define the blood vessels. The system also includes a router that receives the parameters from the parameter generator and processes the parameters of the candidate vessel and the proximal blood vessels. The router also provides an optimal blood vessel from the proximal vessels for creating a graft route between the candidate vessel and the proximal vessel.

This application claims the benefit of IN 1469/KOL/2012, filed on Dec. 27, 2012, which is hereby incorporated by reference in its entirety.

### BACKGROUND

The present embodiments relate to analysis of medical image data.

During corrective surgeries for cerebral infarct and ischaemia, surgeons first assess the extent of Cerebral tissue damage, a candidate blood vessel affected and the functional impairment in the patient. Also, the surgeons are to decide for a graft route to create between the candidate blood vessels and a proximal vessel in proximity to the candidate vessel. Further, due to a high dependency on continual oxygen supply, brain surgeries are to be performed keeping the brain actively perfused. This provides that the surgeons have lesser time to operate and less room for trial surgeries on table.

Surgeons make decisions regarding the graft route to create between the candidate blood vessels and a proximal vessel in proximity to the candidate vessel on the operating table during the surgery and also rely on their experience.

This practice has considerable risk. Surgeons take calculated risks while deciding the ideal by pass route to re-establish perfusion for the affected part of the brain.

Surgeons perform surgeries based on text book inputs and collective experience.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a graft route between vessels is efficiently provided.

According to one embodiment of the system for analyzing medical image data, the medical image data includes data related to at least a candidate blood vessel affected due to change in blood perfusion behavior through the candidate blood vessel and various proximal blood vessels in proximity to the candidate blood vessel in a medical image. The system includes a parameter generator that receives the medical image data, processes the medical image data and generates parameters that define the blood vessels. The system also includes a router that receives the parameters from the parameter generator and processes the parameters of the candidate vessel and/or the parameters of the proximal blood vessels and provides an order of optimal blood vessels out of the proximal blood vessels for creating a graft route between the candidate vessel and the proximal vessel. This provides for various options for a surgeon to choose an alternative graft route.

According to another embodiment of the system, the parameters of the blood vessels include the length of the blood vessels, diameter of the blood vessels, structural relationships between the blood vessels, or a combination thereof. Such parameters provide good definitions for blood vessels.

According to yet another embodiment of the system, the router further processes parameters of the candidate blood vessel and/or parameters of the proximal blood vessel, and generates post flow rate through the candidate blood vessel and/or the proximal blood vessel if the candidate blood vessel is connected to the proximal blood vessel. This provides a pre-estimate to the surgeon about the blood flow rate through the vessels post grafting of the vessels.

According to one embodiment of the system, the router processes parameters of the proximal blood vessels and/or the candidate vessel, and estimates a length of graft required for connecting the candidate vessel and the optimal vessel. This provides for an estimate of graft length to connect the candidate vessel and the optimal vessel before starting the surgery.

According to another embodiment of the system, the router processes parameters of the proximal blood vessels and/or the candidate vessel, and estimates a candidate location of the candidate vessel for connecting the optimal vessel. This provides for an estimate of a point or a range of points at which the candidate vessel is to be connected to the optimal vessel before starting the surgery.

According to yet another embodiment of the system, the router processes parameters of the proximal blood vessels and/or the candidate vessel, and estimates a proximal location of the proximal vessel for connecting the optimal vessel. This provides for an estimate of a point and/or a range of points at which the optimal vessel is to be connected to the candidate vessel before starting the surgery.

### BRIEF DESCRIPTION OF THE DRAWINGS

FIG. 1 shows a schematic diagram of one embodiment of a system for analyzing medical image data; and

FIG. 2 shows multiple exemplary graft routes available for grafting a candidate vessel.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not obscure the embodiments herein. The examples used herein are intended merely to facilitate an understanding of ways in which the embodiments may be practiced and to further enable those of skill in the art to practice the embodiments. Accordingly, the examples should not be construed as limiting the scope of the embodiments herein.

Prior to explaining functioning of the system through various embodiments, some of the terminology used herein will be explained.

“Parameter generator” and “router” may be processors that are logic circuitry that responds to and processes the basic instructions for performing a function. The parameter generator and the router may be a central processing unit of a personal computer adapted to perform the function, or microprocessors that are multipurpose, programmable devices that accept digital data as input, process the digital data according to instructions stored in a memory, and provide results as output. The parameter generator and the router may be any other computing device configured to perform functions of the parameter generator and/or the router according to one or more of the present embodiments. Technical difference between the parameter generator and the router are explained through there functionalities while explaining the figures.

“Medical image” and “blood vessel”: Medical image is a visual representation of an anatomy of a human body that includes vessels. The vessels are the part of the circulatory system that transports blood throughout the body.

“Candidate blood vessel”, “proximal blood vessel” and “optimal blood vessel” are blood vessels. The candidate blood vessel is a blood vessel that is affected due to change in blood perfusion behavior through the candidate blood vessel. The proximal blood vessels are blood vessels that are in proximity to the candidate blood vessel, and the optimal blood vessel is the blood vessel that is suggested for creating a graft with the candidate blood vessel.

“Parameters” of the blood vessels define the blood vessels. Some examples of blood vessels are length of the blood vessels, diameter of the blood vessels, and structural relationship between the blood vessels.

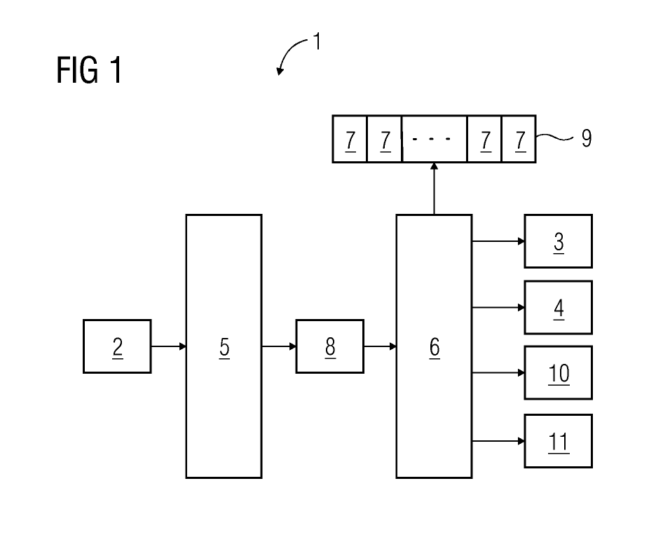

FIG. 1 shows one embodiment of a system 1 for analyzing medical image data 2. The medical image data 2 includes data related to a candidate blood vessel affected due to change in blood perfusion behavior through the candidate blood vessel and related to various proximal blood vessels in proximity to the candidate blood vessel in the medical image data. The system includes a parameter generator 5 that receives the medical image data 2, processes the medical image data 2 and generates parameters 6 that define the blood vessels. The parameters 8 of the blood vessels may be length of the blood vessels, diameter of the blood vessels, and a structural relationship between the blood vessels, or any other aspects that may define the blood vessels.

The system 1 further includes a router 6 that receives the parameters 8 from the parameter generator 5, processes the parameters 8 of the candidate vessel and/or the parameters 8 of the proximal blood vessels, and provides an order 9 of optimal blood vessels 7 out of the proximal blood vessels for creating a graft route between the candidate vessel and the proximal vessel. In an alternate embodiment, the router 6 may not provide the order 9 of the optimal blood vessels 7. Rather, the router 6 just provides one optimal blood vessel 7 from the proximal vessels for creating a graft route between the candidate vessel and the proximal vessel.

The router 6 also processes parameters 8 of the candidate blood vessel and/or the parameters of the proximal blood vessel, and generates post flow rate 10 through the candidate blood vessel and/or the proximal blood vessel when the candidate blood vessel is connected to the proximal blood vessel. In an alternate embodiment, the router 6 only provides the optimal vessel 7 and may not estimate blood flow rate 10 through the candidate blood vessel and/or the proximal blood vessel.

The router 6 further processes parameters 8 of the proximal blood vessel and/or the parameters of the candidate blood vessel, and estimates a length 11 of graft required for connecting the candidate vessel and the optimal vessel. In an alternate embodiment, the router 6 may not estimate the length 11 of graft. Rather, the router 6 provides the optimal blood vessel 7 or generates post flow rate 10 through the candidate blood vessel and/or the proximal blood vessel.

The router 6 also processes parameters 8 of the proximal blood vessel and/or the parameters of the candidate blood vessel, and estimates a candidate location 3 of the candidate vessel for connecting the candidate vessel and the optimal vessel. In an alternate embodiment, the router 6 may not estimate the candidate location 3. Rather, the router 6 provides the optimal blood vessel 7 or generates post flow rate 10 through the candidate blood vessel and/or the proximal blood vessel or estimates the length 11 of graft required.

The router 6 processes parameters 8 of the proximal blood vessel and/or the parameters of the candidate blood vessel, and estimates an optimal location 4 of the optimal vessel for connecting optimal vessel to the candidate vessel. In an alternate embodiment, the router 6 may not estimate the optimal location 4. Rather, the router 6 provides the optimal blood vessel 7 or generates post flow rate 10 through the candidate blood vessel and/or the proximal blood vessel or estimates the length 11 of graft required.

One way for identifying the optimal vessel 7 is to perform blood flow analysis through the proximal vessel and/or the candidate vessel using some known methods. For example:

A=π*(r)²=π*(D/2)²

Q=V*A

where:
π=mathematical constant approximately equal to 3.14159.
V=velocity in meters per second (m/sec)
Q=flow rate in liters per minute (mL/min)
r=radius of artery in millimeters (mm)
D=diameter of artery millimeters (mm)

Also, the laminar flow through the proximal vessels and/or the candidate vessel may be considered while determining the optimal vessel 7 by determining Reynolds number (Re), which is given by,

Re=ρvL/μ

where:
ρ=density of the fluid (1060 kg/m3)
v=flow velocity
L=length of the section of a branch of the blood vessel
μ=viscosity of blood (3*10-3 Pa.s)

If Re<2300, then the blood flow through the blood vessels is laminar. Friction factor (f) is given by Darcy friction factor, f=64/Re.

Also, the turbulent flow through the proximal vessels and/or the candidate vessel may be considered while determining the optimal vessel 7 by using Colebrook equation, which is given as

1/f^{1/2}=−2log₁₀(k/3.7 D+2.51/Re*f^{1/2})

where:
D=internal diameter of the branch
Re=Reynolds number
f=Darcy friction factor
k=roughness height

Head loss may be calculated using the Darcy-Weisbach formula:

h_{f}=8 fLQ²/gπ²D⁵

where,
f=friction factor
L=length of the branch
v=velocity of the branch
g=acceleration due to gravity
D=diameter of the branch

Further, for determining the optimal vessel 7, flow balancing methodologies (e.g., the Hardy Cross method) may be used.

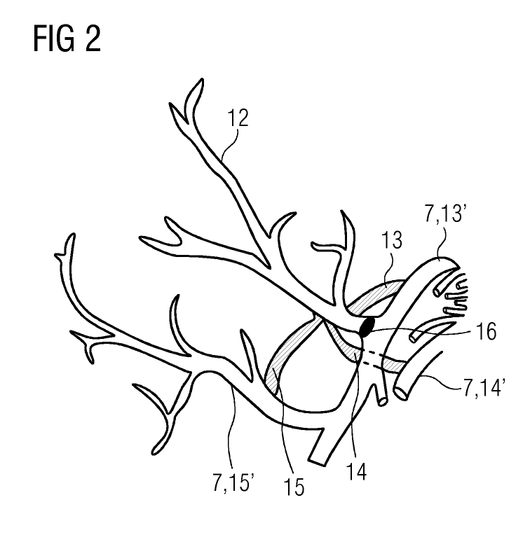

FIG. 2 shows multiple exemplary graft routes available for grafting a candidate vessel.

In FIG. 2, a candidate vessel 12 is blocked by a blockage 16, and various grafts 13, 14, 15 are suggested to be created between the candidate vessel 12 and optimal vessels 13′, 14′, 15′, 7. The graft 13 between the candidate vessel 12 and the optimal vessel 7, 13′ has first priority. The graft 14 between the candidate vessel 12 and the optimal vessel 7, 14′ is placed. The graft 15 between the candidate vessel 12 and the optimal vessel 7, 15′ is then placed in order 9 of the optimal blood vessels considering the blood flow balancing between the candidate vessel 12 and the optimal vessels 13′, 14′, 15′, 7 when the connection is made between the candidate vessel 12 and any of the optimal vessels 13′, 14′, 15′, 7.

Such type of provisions for graft route identification may be useful for any surgery to restore blood supply within the cranium and anywhere else in the body and excision surgeries within the brain (e.g., tumor, space occupying lesions (SOL), parasites, and stroke)

The application of this technique may also be extended to correct some congenital anomalies.

Patients suffering from transient ischaemic attacks (TIA) may be of special interest and may benefit from the application of one or more of the present embodiments.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A system for analyzing medical image data, wherein the medical image data comprises data related to at least a candidate blood vessel affected due to change in blood perfusion behavior through the candidate blood vessel and related to various proximal blood vessels in proximity to the candidate blood vessel in a medical image, the system comprising:
a parameter generator configured to:
receive the medical image data;
process the medical image data; and
generate parameters that define blood vessels;
a router configured to:
receive the parameters from the parameter generator;
process the parameters of the candidate blood vessel, the proximal blood vessels, or the candidate blood vessel and the proximal blood vessels; and
provide an optimal blood vessel from the proximal blood vessels for creating a graft route between the candidate vessel and the proximal vessel.

2. The system of claim 1, wherein the router is further configured to provide an order of optimal blood vessels out of the proximal blood vessels for creating the graft route between the candidate vessel and the proximal vessel.

3. The system of claim 1, wherein the parameters of the blood vessels includes length of the blood vessels, diameter of the blood vessels, structural relationships between the blood vessels, or a combination thereof.

4. The system of claim 1, wherein the router is further configured to:
process the parameters of the candidate blood vessel, the proximal blood vessel, or the candidate blood vessel and the proximal blood vessel; and
generate post flow rate through the candidate blood vessel, the proximal blood vessel, or the candidate blood vessel and the proximal blood vessel when the candidate blood vessel is connected to the proximal blood vessel.

5. The system of claim 1, wherein the router is further configured to:
process parameters of the proximal blood vessel, the candidate blood vessel, or the proximal blood vessel and the candidate blood vessel; and
estimate a length of a graft required for connecting the candidate blood vessel and the proximal blood vessel.

6. The system of claim 1, wherein the router is configured to:
process parameters of the proximal blood vessel, the candidate blood vessel, or the proximal blood vessel and the candidate blood vessel; and
estimate a candidate location of the candidate blood vessel for connecting the candidate blood vessel and the proximal blood vessel.

7. The system of claim 1, wherein the router is further configured to:
process parameters of the proximal blood vessel, the candidate blood vessel, or the proximal blood vessel and the candidate blood vessel; and
estimate an optimal location of the proximal blood vessel for connecting the proximal blood vessel to the candidate blood vessel.

8. The system of claim 2, wherein the parameters of the blood vessels includes length of the blood vessels, diameter of the blood vessels, structural relationships between the blood vessels, or a combination thereof.

9. The system of claim 8, wherein the router is further configured to:
process the parameters of the candidate blood vessel, the proximal blood vessel, or the candidate blood vessel and the proximal blood vessel; and
generate post flow rate through the candidate blood vessel, the proximal blood vessel, or the candidate blood vessel and the proximal blood vessel when the candidate blood vessel is connected to the proximal blood vessel.

10. The system of claim 3, wherein the router is further configured to:
process the parameters of the candidate blood vessel, the proximal blood vessel, or the candidate blood vessel and the proximal blood vessels; and
generate post flow rate through the candidate blood vessel, the proximal blood vessel, or the candidate blood vessel and the proximal blood vessel when the candidate blood vessel is connected to the proximal blood vessel.

11. A method for analyzing medical image data, wherein the medical image data comprises data related to at least a candidate blood vessel affected due to change in blood perfusion behavior through the candidate blood vessel and related to various proximal blood vessels in proximity to the candidate blood vessel in a medical image, the method comprising:
receiving the medical image data;
processing the medical image data;
generating, by a parameter generator, parameters, wherein the parameters define blood vessels;
receiving, by a router, the parameters from the parameter generator;
processing the parameters of the candidate blood vessel, the proximal blood vessels, or the candidate blood vessel and the proximal blood vessels; and
providing, by the router, an optimal blood vessel from the proximal blood vessels for creating a graft route between the candidate blood vessel and the proximal blood vessel.

12. The method of claim 11, further comprising:
providing, by the router, an order of optimal blood vessels out of the proximal blood vessels for creating the graft route between the candidate vessel and the proximal vessel.

13. The method of claim 11, further comprising:
generating, by the router, a post flow rate through the candidate blood vessel, the proximal blood vessel, or the candidate blood vessel and the proximal blood vessel based on processing of parameters of the candidate blood vessel, the proximal blood vessel, or the candidate blood vessel and the proximal blood vessel when the candidate blood vessel is connected to the proximal blood vessel.

14. The method of claim 11, further comprising:
estimating, by the router, a length of a graft required for connecting the candidate blood vessel and the proximal blood vessel based on processing of parameters of the proximal blood vessel, the candidate blood vessel, or the proximal blood vessel and the candidate blood vessel.

15. The method of claim 11, further comprising:
estimating, by the router, a candidate location of the candidate blood vessel for connecting the candidate blood vessel and the proximal blood vessel based on processing of parameters of the proximal blood vessel, the candidate blood vessel, or the proximal blood vessel and the candidate blood vessel.

16. The method of claim 11, further comprising:
estimating, by the router, an optimal location of the proximal blood vessel for connecting the proximal blood vessel to the candidate blood vessel based on processing of parameters of the proximal blood vessel, the candidate blood vessel, or the proximal blood vessel and the candidate blood vessel.

17. The method of claim 12, further comprising:
generating, by the router, a post flow rate through the candidate blood vessel, the proximal blood vessel, or the candidate blood vessel and the proximal blood vessel based on processing of parameters of the candidate blood vessel, the proximal blood vessel, or the candidate blood vessel and the proximal blood vessel when the candidate blood vessel is connected to the proximal blood vessel.

18. The method of claim 12, further comprising:
estimating, by the router, a length of a graft required for connecting the candidate blood vessel and the proximal blood vessel based on processing of parameters of the proximal blood vessel, the candidate blood vessel, or the proximal blood vessel and the candidate blood vessel.

19. The method of claim 12, further comprising:
estimating, by the router, a candidate location of the candidate blood vessel for connecting the candidate blood vessel and the proximal blood vessel based on processing of parameters of the proximal blood vessel, the candidate blood vessel, or the proximal blood vessel and the candidate blood vessel.

20. The method of claim 12, further comprising:
estimating, by the router, an optimal location of the proximal blood vessel for connecting the proximal blood vessel to the candidate blood vessel based on processing of parameters of the proximal blood vessel, the candidate blood vessel, or the proximal blood vessel and the candidate blood vessel.
